(19) United States
(12) Patent Application Publication
(10) Pub. No.: US 2004/0182933 A1
(43) Pub. Date: Sep. 23, 2004

(54) Light source structure without moving parts for a laser barcode scanner

(76) Inventor: Kai-Yuan Tien, Taipei (TW)

Correspondence Address: Kai-Yuan Tien, PO Box 82-144, Taipei, TW

(21) Appl. No.: 10/388,435

(22) Filed: Mar. 17, 2003

(51) Int. Cl. G06K 15/12

(52) U.S. Cl. 235/462.41

(57) ABSTRACT

A light source structure of a laser barcode scanner includes a laser diode, a collimator, a standing cylindrical lens, a light condensing lens, and a linear sensor. The laser diode provides a laser light which passes through a collimator to form parallel point-shape laser beam. Then, the point-shape laser beam passes through the standing cylindrical lens to become a linear-shape laser beam perpendicular to the standing cylindrical lens. Thereafter, the linear-shape laser beam is projecting on a barcode and then the laser barcode image will be reflected back and focused to the linear sensor by the light condensing lens. The linear sensor will convert the reflected laser barcode image into electronic signals. Then, the electronic signals will be decoded by a decoder into numbers and/or characters represented by the barcode, thereby completing the scanning function of the whole laser barcode scanner.

### BACKGROUND OF THE INVENTION

1. Field of the Invention

This invention is related to a light source structure without moving parts for a laser barcode scanner, and in particular to one which have a linear shape scanning light beam without a rotating mirror or vibrating mirror inside, thereby lowering the manufacturing cost and reducing the operational difficulties caused by failure of moving parts, and so prolonging the lifetime of the barcode scanner.

2. Description of the Prior Art

The laser barcode scanners were invented several decades ago. The principle of these scanners is to use a laser beam to scan a barcode and then the laser barcode image will be reflected from the barcode to a point-type sensor (such as a photodiode or phototransistor). Then, the reflected laser barcode image is converted into electronic signals which will be decoded by a decoder into numbers and/or characters represented by the barcode.

The original laser light comes from a point-shape laser beam, and so in order to perform the scanning of a barcode, there are two ways: one is moving the laser light by a hand; the other is moving the laser light by a mirror, as shown in FIGS. 1 and 2.

As shown in FIG. 1, the light source structure includes a polygonal mirror 11 having a number of sides, each side of which is an independent mirror, so that the light emitted by laser diode 13 passes through a collimator 14 to be converted into parallel point-shape laser beam to one side of the polygonal mirror 11. Then, the parallel point-shape laser beam will be reflected to the barcode 2 and generate one laser point on barcode, and then the laser point image will be reflected back to the polygonal mirror 11. Thereafter, the reflected laser point image will be reflected again by polygonal mirror 11 and focused to a point-type sensor 15 by a light condensing lens. When the polygonal mirror 11 rotates, all sides of the polygonal mirror 11 will move and change the position and then the parallel point-shape laser beam will be reflected by the mirror at different angles, thereby enabling the parallel point-shape light beam to project on different positions of the barcode, and therefore causing the movement of the laser point. Due to the rapid rotation of the polygonal mirror 11, the reflected laser point will be moved rapidly, thereby producing the scanning effect.

Referring to FIG. 2, another conventional light structure is shown which has a vibrating mirror 12. When the laser diode 13 emits laser light which passes through a collimator 14 to be converted into parallel point-shape laser beam, the parallel point-shape laser beam are projected on the vibrating mirror 12 and then reflected to the barcode 2 and generate one laser point on barcode 12, and thereafter the laser point image will be reflected back to the vibrating mirror 12 which will reflect the laser point image toward the light condensing lens and focused to a point-type sensor 15 by the light condensing lens. The vibrating mirror 12 vibrates back and forth to produce different reflective angles, so as to produce the same scanning effect as shown in FIG. 1.

Because of the rapid movement of the polygonal mirror 11 and the vibrating mirror 12, a linear scanning light will be formed to cover the whole barcode 2, so as to achieve the scanning operation.

The scanners requiring manual movement occupy no more than one percent of the market. The scanners with the rotating mirror or the vibrating mirror occupy the remainder of the laser barcode scanner market. However, the manufacturing cost for the rotating polygonal mirror or the vibrating mirror is expensive, the mirrors can be easily broken and are difficult to manufacture.

Therefore, it is an object of the present invention to provide a light source without moving parts for a laser barcode scanner which can obviate and mitigate the above-mentioned drawbacks.

### SUMMARY OF THE INVENTION

This invention is related to a light source structure without moving parts for a laser barcode scanner.

It is the primary object of the present invention to provide a light source structure without moving parts for a laser barcode scanner, wherein the laser diode provides a laser light which passes through a collimator to form parallel point-shape laser beam, and then the point-shape laser beam pass through a standing cylindrical lens to become a linear-shape laser beam perpendicular to the standing cylindrical lens, and thereafter the linear-shape laser beam is projecting on a barcode, and then the laser barcode image will be reflected back and focused to a linear sensor by a light condensing lens and finally the linear sensor will convert the reflected laser barcode image into electronic signals which will be decoded by a decoder into numbers and/or characters represented by the barcode, thereby completing the scanning function of the whole laser barcode scanner.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates a conventional light source structure of a laser barcode scanner;

FIG. 2 illustrates another conventional light source structure of a laser barcode scanner; and

FIG. 3 illustrates a light source structure without moving parts for a laser barcode scanner.

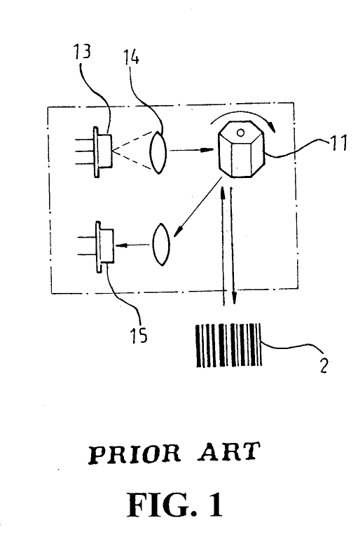

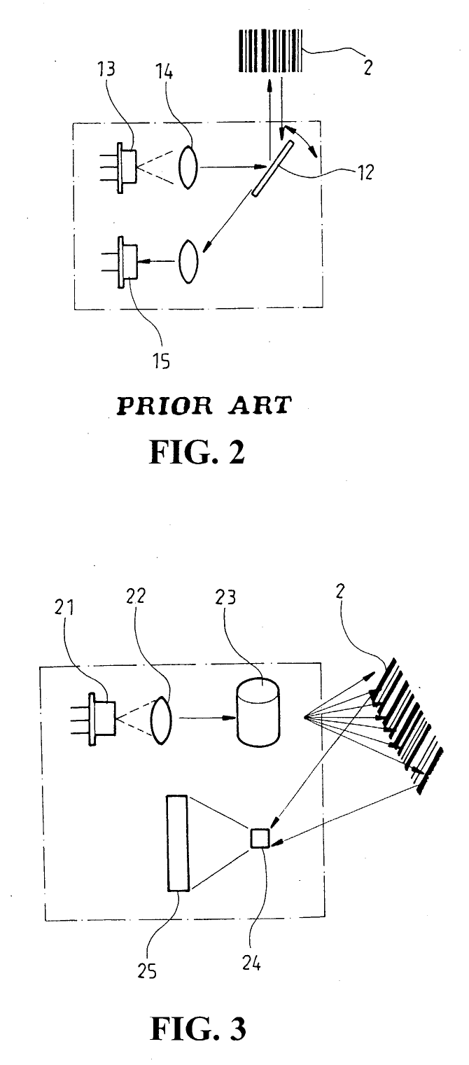

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIG. 3, the light source structure without moving parts for a laser barcode scanner according to the present invention comprises a laser diode 21, a collimator 22, a standing cylindrical lens 23, a light condensing lens 24, and a linear sensor 25 (such as a charge coupled device linear sensor or a complementary metal oxide semiconductor linear sensor). The laser diode 21 provides a laser light which passes through the collimator 22 to form parallel point-shape laser beam. Then, the parallel point-shape laser beam passes through the standing cylindrical lens 23 to become a linear-shape laser beam perpendicular to the standing cylindrical lens 23. Then, the linear-shape laser beam is projecting on a barcode 2 and then the laser barcode image will be reflected back and focused to a linear sensor 25 by a light condensing lens 24. The linear sensor 25 will convert the reflected laser barcode image into electronic signals. Then, the electronic signals will be decoded by a decoder (not shown) into numbers and/or characters represented by the barcode, thereby completing the scanning function of the whole laser barcode scanner.

According to the light structure mentioned above, the parallel point-shape laser beam is converted by the standing cylindrical lens 23 into a synchronous linear-shape laser beam directly, and so it is unnecessary to have moving parts, unlike the conventional barcode scanner, and is easy to assemble and to manufacture.

The cross-section of the standing cylindrical lens 23 the laser beam passing through may be circular, elliptical, asherical or curved shape, while the cross-section of other portion of the standing cylindrical lens 23 that the laser beam does not pass through may be in any shape.

It will be understood that each of the elements described above, or two or more together may also find a useful application in other types of methods differing from the type described above.

While certain novel features of this invention have been shown and described and are pointed out in the annexed claim it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light source structure for a laser barcode scanner comprising a laser diode, a collimator, a standing cylindrical lens, a light condensing lens, and a linear sensor, wherein said laser diode provides a laser light which passes through said collimator to form parallel point-shape laser beam, said parallel point-shape laser beam passing through said standing cylindrical lens to become a linear-shape laser beam perpendicular to said standing cylindrical lens, said linear-shape laser beam projecting on a barcode and then the laser barcode image will be reflected back and focused to said linear sensor by said light condensing lens.

2. The light source structure for a laser barcode scanner as claimed in claim 1, wherein cross-section of said standing cylindrical lens the laser beam passing through is circular, elliptical, asherical or curved shape, while the cross-section of other portion of the said standing cylindrical lens that the laser beam does not pass through is in any shape.

3. The light source structure for a laser barcode scanner as claimed in claim 1, wherein said linear sensor is a charge coupled device linear sensor.

4. The light source structure for a laser barcode scanner as claimed in claim 1, wherein said linear sensor is a complementary metal oxide semiconductor linear sensor.
